(19) United States
(12) Patent Application Publication
(10) Pub. No.: US 2015/0220717 A1
(43) Pub. Date: Aug. 6, 2015

(54) METHOD FOR ELECTRONICALLY SIGNING ELECTRONIC DOCUMENT USING BIOMETRIC INFORMATION AND METHOD FOR VERIFYING THE ELECTRONIC DOCUMENT

(71) Applicant: SECUCEN CO., LTD., Seoul (KR)

(72) Inventor: Joon Ho Shin, Yongin-si (KR)

(21) Appl. No.: 14/688,887

(22) Filed: Apr. 16, 2015

Related U.S. Application Data
(63) Continuation-in-part of application No. PCT/KR2013/005491, filed on Jun. 21, 2013.

(30) Foreign Application Priority Data
Oct. 16, 2012 (KR) 10-2012-0114739

(51) Int. Cl. G06F 21/32; G06F 21/64

(52) U.S. Cl. CPC G06F 21/32; G06F 21/64

(57) ABSTRACT

Provided is a method for providing a secured electronic document by a biometric information recognition device. The method includes : acquiring biometric information to be inserted into an electronic document; (b) encoding the biometric information according to a biometric data standard together with a hash value of the electronic document and acquisition information of the biometric information; and (c) integrating the encoded biometric information with the electronic document to provide a secured electronic document.

### CROSS-REFERENCE TO RELATED APPLICATIONS

This patent document is a continuation in part application of, and claims priority and benefits of, a Patent Cooperation Treaty (PCT) application number PCT/KR2013/005491 entitled “ELECTRONIC SIGNING METHOD BASED ON BIOMETRIC INFORMATION RECOGNITION AND METHOD FOR VERIFYING ELECTRONICALLY SIGNED ELECTRONIC DOCUMENT BASED ON SAID BIOMETRIC INFORMATION RECOGNITION, AND TERMINAL, SERVER, AND COMPUTER-READABLE RECORDING MEDIUM USING SAME” and filed with the Korean Intellectual Property Office (KIPO) on Jun. 21, 2013, which further claims priority and the benefits of Korean Patent Application No. 10-2012-0114739 filed on Oct. 16, 2012. The entire disclosures of the above applications are incorporated by reference as part of this document.

### TECHNICAL FIELD

This patent document relates to a method for electronically signing an electronic document using biometric information and a method for verifying the electronic document. This patent document also relates to a terminal, a server and a computer-readable recording medium for the methods.

### BACKGROUND

Electronic signature has been discussed in the art. One example disclosed in Korean Patent Application Laid-open Publication No. 10-2009-0016886 discloses a method for generating an encrypted signature. The method includes a step of inputting a signature and a password, a step of encrypting the input password to generate a fake stroke to be added to the signature and insertion location information on the fake stroke, and a step of adding the fake stroke to the signature on the basis of the insertion location information on the fake stroke to generate an encrypted signature. Here, the fake stroke represents an additional stroke generated by a password in addition to a signature input from a signer. By virtue of such a configuration, the reproducibility of an electronic signature may be reduced.

### SUMMARY

Examples of implementations of the disclosed technology include generating an electronic document based on biometric signal recognition in order to secure the integrity of the electronic document.

Examples of implementations of the disclosed technology include securing the authenticity of a signer by virtue of a biometric-signal-based electronic signature in order to effectively prevent denial of signature.

In one aspect, a method for providing a secured electronic document by a biometric information recognition device is provided. The methods may include: acquiring biometric information to be inserted into an electronic document; encoding the biometric information according to a biometric data standard together with a hash value of the electronic document and acquisition time information of the biometric information; and integrating the encoded biometric information with the electronic document to provide a secured electronic document.

In some implementations, the acquiring of biometric information includes obtaining a characteristic portion from the biometric information. In some implementations, the method further comprises, after the encoding the biometric information, converting the encoded biometric information into a mark so that the biometric information is visualized in the secured electronic document. In some implementations, the integrating the encoded biometric information comprises combining the encoded biometric information with a meta field of the electronic document so that the biometric information is non-visually included in the secured electronic document. In some implementations, the biometric data standard includes a common biometric exchange file format (CBEFF). In some implementations, the acquiring the biometric information comprises acquiring encrypted information of the biometric information. In some implementations, the biometric information includes a fingerprint. In some implementations, the encoding the biometric information comprises encoding the biometric information together with an acquisition organ of the biometric information. In some implementations, the mark includes a barcode, a QR code, or any visualized identification mark.

In another aspect, a method for verifying an electronically signed electronic document is provided. The method may include: receiving a verification request from a user terminal together with user's biometric information; acquiring an electronic document to be verified, the electronic document to be verified combined with an encoded biometric information that is obtained by encoding original biometric information according to a biometric data standard together with a hash value of the electronic document and acquisition time information of the original biometric information; decoding the encoded biometric information to acquire (i) the original biometric information, (ii) the hash value of the electronic document, and (iii) the acquisition time information of the original biometric information included in the electronic document; comparing the hash value obtained from the decoding with a hash value directly obtained from the source document of the electronic document, and comparing the original biometric information with the acquired user's biometric information; and determining, based on the comparison, authenticity of the electronic document.

In some implementations, the encoded biometric information is visually combined with the electronic document. In some implementations, the encoded biometric information is combined with the electronic document in the form of a mark. In some implementations, the encoded biometric information is combined with a meta field of the electronic document.

In another aspect, a device for providing a secured electronic document, comprising: a biometric information acquisition unit configured to acquire biometric information to be inserted into an electronic document; a biometric information processing unit configured to encode the biometric information together with a hash value of the electronic document, and acquisition time information of the biometric information; and an electronic signature combining unit configured to integrate the encoded biometric information with the electronic document to provide a secured electronic document.

In some implementations, the biometric information processing unit converts the encoded biometric information into a visualized form including a mark and the electronic signature combining unit integrates the visualized form with the electronic document. In some implementations, the biometric information processing unit inserts the hash value and the acquisition time information into the biometric information as a watermark. In some implementations, the electronic signature combining unit combines the encoded biometric information with a meta field of the electronic document so that the biometric information is non-visually integrated with the electronic document. In some implementations, the biometric information processing unit encodes the biometric information according to a biometric data standard by inserting the biometric information, the hash value, and the acquisition time information into a common biometric exchange file format (CBEFF). In some implementations, the biometric information includes a fingerprint.

In another aspect, a device for verifying an electronically signed electronic document is provided to include: a reception unit configured to receive a verification request from a user terminal together with user's biometric information; an acquisition unit configured to acquire an electronic document to be verified, the electronic document including encoded biometric information associated with raw biometric information encoded based on a biometric data standard together with a hash value of the electronic document and acquisition time information of the raw biometric information; an extraction unit configured to obtain (i) the raw biometric information, (ii) the hash value of the electronic document, and (iii) the acquisition time information of the raw biometric information included in the electronic document; a comparison unit configured to compare the hash value obtained from the decoding with a hash value directly obtained from the source document of the electronic document, and comparing the raw biometric information with user's biometric information; and a verification unit configured to determine, based on the comparison, authenticity of the electronic document.

### BRIEF DESCRIPTION OF THE DRAWINGS

The accompanying drawings are included to provide a further understanding of the disclosed technology, and are incorporated in and constitute a part of this specification.

FIG. 1 is a schematic block diagram illustrating a configuration of an exemplary overall system for providing a secured electronic document according to an embodiment of the disclosed technology;

FIG. 2 is a diagram illustrating a configuration of an exemplary terminal device according to an embodiment of the disclosed technology;

FIG. 3 is a diagram illustrating an exemplary process of generating an secured electronic document according to an embodiment of the disclosed technology;

FIG. 4 is a schematic block diagram illustrating a configuration of an exemplary overall system for verifying an electronic document according to an embodiment of the disclosed technology;

FIG. 5 is a diagram illustrating a configuration of an exemplary terminal device according to an embodiment of the disclosed technology; and

FIG. 6 is a diagram illustrating an exemplary process of verifying an electronic document according to an embodiment of the disclosed technology.

### DETAILED DESCRIPTION OF PREFERRED EMBODIMENTS

The conventional electronic signatures including the example mentioned in the background are mainly focused on generating an encrypted electronic signature. Therefore, there has been a limitation on verifying the integrity of an electronic document with the electronic signature. Furthermore, the conventional electronic signatures employ complicated encryptions on the electronic signature to prevent forgery of the electronic signature. Thus, the conventional electronic signatures do not provide a simple and efficient way to prevent forgery of an electronic signature using a personal and unique biometric signal.

Hereinafter, various implementations of the disclosed technology will be described in detail with reference to the accompanying drawings.

The term “biometric information” used herein represents identifiable unique information acquired from a human body. For example, the biometric information may include information acquired from a fingerprint, palm lines, DNA, iris, face, entire body or the like. A fingerprint is described as an example of the biometric information, and other biometric information can be used in various implementations of this patent document. In some implementations, the biometric information may indicate biometric information itself. In some implementations, the biometric information may indicate characteristic information that is obtained from the biometric information. For example, the characteristic information may include feature point information.

The term “biometric data standard” used herein represents a type of protocol used for encoding or decoding acquired biometric information. The biometric data standard may include a common biometric exchange formats framework (CBEFF), but is not limited thereto and may include various standards such as x.984 and XCBF.

The term “mark” used herein represents not only a barcode or a QR code but also various identification marks that can be visualized. Here, the term “visualization” represents various manners that can be used for a visual identifications through the naked eye or a device.

<Configuration of Overall System for Inserting Biometric-Information-Recognition-Based Electronic Signature into Electronic Document>

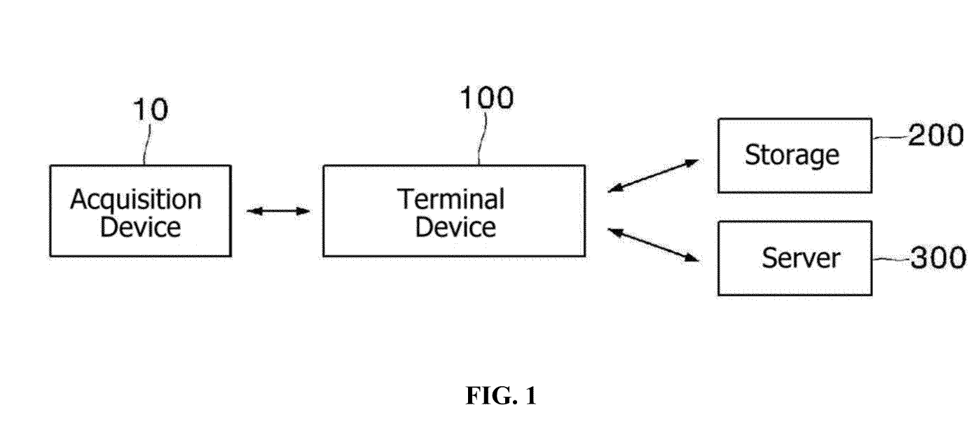

FIG. 1 is a schematic block diagram illustrating an exemplary configuration of an overall system for inserting a biometric-information-recognition-based electronic signature into an electronic document according to one implementation of the disclosed technology.

As illustrated in FIG. 1, the exemplary overall system may include a biometric information acquisition device 10, a terminal device 100 for generating an electronic document (hereinafter, referred to as a terminal device 100), a storage unit 200, and a server 300.

The foregoing elements may communicate with each other wirelessly and/or by wire.

The terminal device 100 enables a user to access and communicate with the storage unit 200 and/or the server 300 through a communication network. The terminal device 100 may include an electronic device such as a personal computer (e.g., a desktop computer, a laptop computer, or the like), a workstation, a PDA, a web pad, a smartphone, a tablet PC, or the like. Any electronic device including a memory, a microprocessor, and the like may be adopted as the terminal device 100 in various implementations of the disclosed technology.

When biometric information is acquired, the terminal device 100 may insert the biometric information as an electronic signature into a certain electronic document so as to provide the electronic document with the electronic signature. This will be described in detail later.

The biometric information acquisition device 10 may be connected to the terminal device 100, and may collect the biometric information from the user. In some implementations, the biometric information acquisition device 10 may not be separate from the terminal device 100, but may be built in or integrated with the terminal device 100. For example, the biometric information may be acquired using a touch screen or a camera module included in the terminal device 100. In this case, the biometric acquisition device 10 may be configured with a touch screen or a camera module of the terminal device 100.

The storage unit 200 may store the electronic document into which the electronic signature has been inserted by the terminal device 100. In some embodiments, the storage unit 200 is positioned in an internal memory of the terminal device 100. In other embodiments, the storage unit 200 may be present outside the terminal device 100. In this case, the terminal device 100 may access data stored in the storage unit 200 through a communication network.

The server 300 may store data including a key and an identification number of an electronic document. The server 300 may compare the stored data with the biometric information, for example, the fingerprint, and identify the user. By doing so, the server may prevent the true electronic signature inserted into the electronic document from being denied.

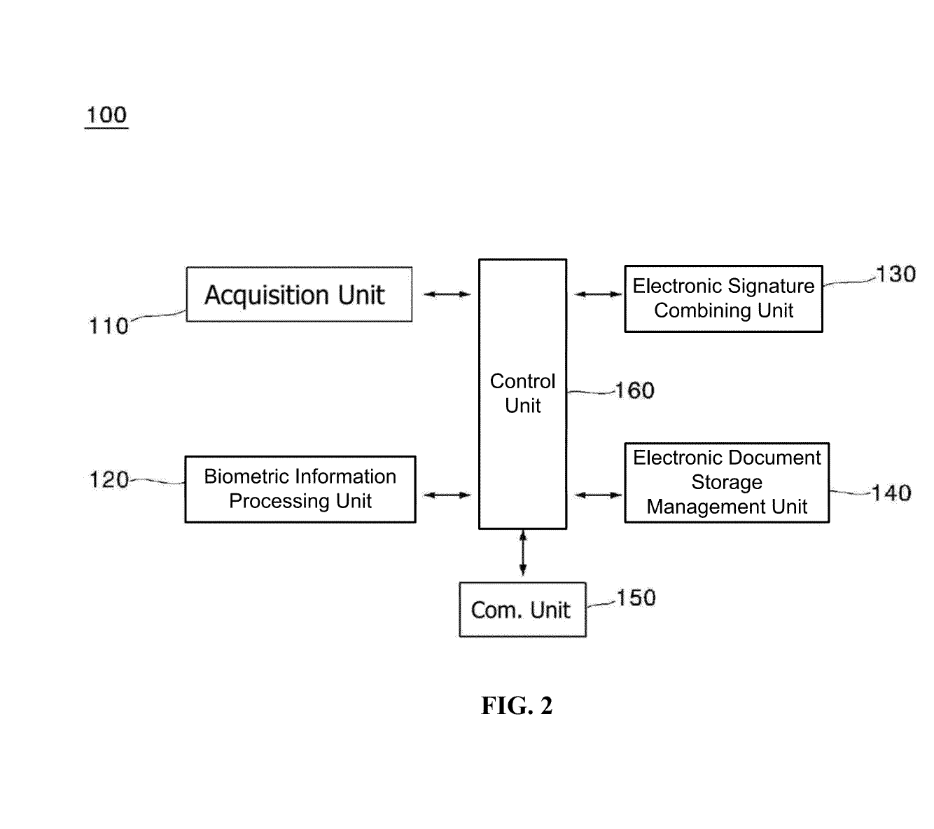

FIG. 2 is a diagram illustrating an exemplary configuration of the terminal device 100 according to an embodiment of the disclosed technology.

As illustrated in FIG. 2, the terminal device 100 according to an embodiment of the disclosed technology may include a biometric information acquisition unit 110, a biometric information processing unit 120, an electronic signature combining unit 130, an electronic document storage management unit 140, a communication unit 150, and a control unit 160. In some implementations of the disclosed technology, at least a portion of the foregoing elements of the terminal device 100 may be configured as a program module. Such a program module may be included in the terminal device 100 in various forms including an operating system, application software, or other program modules. Furthermore, such a program module may be physically stored in memory devices, for example, a remote external memory device communicable with the terminal device 100. Furthermore, such a program module may include various configurations that perform a specific task or process a specific data as described in this patent document, which include a routine, a subroutine, a program, an object, a component, a data structure, or the like.

The biometric information acquisition unit 110 may serve to acquire biometric information to be inserted into an electronic document. Here, the biometric information acquisition unit 110 may acquire the biometric information in various manners. In some implementations, the biometric information acquisition unit 110 may acquire the biometric information through external devices connected to the terminal device 100 or a touch screen or a camera module built in the terminal device 100.

The biometric information processing unit 120 may encode the acquired biometric information and provide the encoded biometric information in various forms including a mark, watermark, or meta field. The biometric information processing unit 120 may encode biometric information together with various information. In some implementations, the biometric information processing unit 120 may encode biometric information using a hash value of an electronic document, and acquisition information on the biometric information (e.g., information on a time at which the biometric information is acquired) according to a biometric data standard. For example, if the biometric data standard includes the common biometric exchange file format (CBEFF), the information below may be inserted into the CBEFF to perform the encoding:

(1) biometric information (As discussed above, biometric information includes biometric information itself or characteristic information obtained from biometric information);

(2) a hash value of an electronic document; and

(3) acquisition information on the biometric information.

In some implementations, (4) information on an acquisition organ of the biometric information may be further included to the CBEFF to facilitate encoding. The acquisition organ information is optional and thus, it can be omitted from the CBEFF.

In some implementations, the biometric information acquisition unit 110 may acquire encrypted biometric information. In this case, the biometric information processing unit 120 encodes, according to the biometric data standard, the encrypted biometric information (or the encrypted characteristic information on the biometric information), the hash value of the electronic document, and the acquisition information of the biometric information.

In some implementations, the biometric information processing unit 120 converts the encoded biometric data into various form including visualized forms or non-visualized forms. The electronic signature combining unit 130 may combine the encoded biometric information with the electronic document. In some implementations, when the biometric information processing unit 120 converts the encoded biometric information into the form of the mark, the electronic signature combining unit 130 may combine the electronic document with the mark, thereby providing the secured electronic document. In this case, the secured electronic document has a form in which the mark is combined with the electronic document.

In another embodiment of the disclosed technology, when the biometric information processing unit 120 encodes the biometric information and does not convert the encoded biometric information into the form of a mark, the electronic signature combining unit 130 may combine the encoded biometric information with a meta field of the electronic document, thereby providing the secured electronic document. In this case, the secured electronic document has the form in which the biometric information is non-visually combined with the electronic document. Here, the meta field represents a region for recording meta data.

The secured electronic document into which the electronic signature is inserted may be transmitted through the electronic document storage management unit 140 and stored in the storage unit 200 so as to be stored therein.

In some implementations of the disclosed technology, the biometric information processing unit 120 may use the watermark in providing the secured electronic document. For example, once the biometric information acquisition unit 110 acquires the biometric information to be inserted into the electronic document, the biometric information processing unit 120 may insert the hash value of the electronic document and the acquisition information of the biometric information into the acquired biometric information as a watermark. In this case, the biometric information processing unit 120 may convert the biometric information to which the hash value and the acquisition information have been inserted as the watermark (“biometric information including the watermark”) into a mark. Thereafter, the electronic signature combining unit 130 may combine the electronic document with the mark, thereby providing the secured electronic document. The secured electronic document may be stored in the storage unit 200 through the electronic document storage management unit 140.

According to the above embodiment, the biometric information processing unit 120 may further perform encoding of the biometric information including the watermark according to the biometric data standard. In this case, once the biometric information processing unit 120 converts the biometric information including the watermark encoded with the biometric data standard into the form of a mark, the electronic signature combining unit 130 may combine the mark with the electronic document.

When the biometric information processing unit 120 encodes the biometric information including the watermark with the biometric data standard, not only the biometric information including the watermark but also the signature time and the hash value of the electronic document may be additionally encoded in accordance with the biometric data standard. In some implementations, the acquisition organ information on the biometric information may be additionally encoded with the biometric data standard.

The biometric information processing unit 120 may further perform an operation of compressing the biometric information including the watermark using a compressing algorithm. In this case, the biometric information processing unit 120 may convert the compressed biometric information including the watermark into a mark.

In still another implementation of the disclosed technology, once the biometric information acquisition unit 110 acquires the biometric information to be inserted into the electronic document in the form of a first image, the biometric information processing unit 120 may extract the characteristic information from the biometric information of the first image.

Then, the biometric information processing unit 120 may convert the extracted characteristic information into the form of a second image. The biometric information processing unit 120 may convert the extracted characteristic information as a watermark by inserting the hash value of the electronic document and the acquisition information into the second image. Although it has been explained that the biometric information processing unit 120 acquires the biometric information in the form of the first image, in some implementations, the biometric information processing unit 120 may receive the characteristic information obtained from the biometric information by extracting characteristic information from the first image. Furthermore, the biometric information processing unit 120 may receive the biometric information obtained by converting the first image from which the feature point has been extracted into the second image. Here, the electronic signature combining unit 130 may convert the second image including the watermark into a mark, and then may combine the electronic document with the mark. In still another embodiment, the second image including the watermark may be combined with the meta field of the electronic document. The secured electronic document prepared in this manner is stored in the storage unit 200 by the electronic document storage management unit 140.

In still another embodiment of the disclosed technology, once the biometric information acquisition unit 110 acquires the biometric information to be inserted into the electronic document, the biometric information processing unit 120 may insert the hash value of the electronic document and the acquisition information into the biometric information as a watermark. Furthermore, the electronic signature combining unit 130 may combine the biometric information including the watermark with the meta field of the electronic document. The secured electronic document prepared in this manner is stored in the storage unit 200 through the electronic document storage management unit 140. In some implementations, the biometric information processing unit 120 may encode the biometric information including the watermark with the biometric data standard, so that the electronic signature combining unit 130 may combine the meta field of the electronic document with the biometric information including the watermark encoded with the biometric data standard.

The communication unit 150 allows the terminal device 100 to communicate with an external device.

The control unit 160 controls data flows of the biometric information acquisition unit 110, the biometric information processing unit 120, the electronic signature combining unit 130, the electronic document storage management unit 140, and the communication unit 150.

The control unit 160 controls flows of data from the outside or among elements of the terminal device 100 so that the biometric information acquisition unit 110, the biometric information processing unit 120, the electronic signature combining unit 130, the electronic document storage management unit 140, and the communication unit 150 may perform the functions thereof.

It has been described that the steps for preparing a secured electronic document are performed in the terminal device 100. However, it is also possible that some steps may be remotely performed using the server 300.

For example, the server 300 may be configured to include an element acquisition unit (not shown), a biometric information processing unit (not shown), an electronic signature combining unit, and an electronic document storage management unit. The element acquisition unit (not shown) of the server 300 may receive, from the terminal device 100, (1) the biometric information or characteristic information on the biometric information, (2) the hash value of the electronic document, and (3) the acquisition information to be inserted into the electronic document. Once the element acquisition unit of the server 300 receives such data, the biometric information processing unit (not shown) of the server 300 may encode the biometric information or the feature point information on the biometric information, the hash value of the electronic document, and the acquisition information with the biometric data standard. Furthermore, when the information encoded with the biometric data standard is converted into a mark by the biometric information processing unit of the server, the electronic signature combining unit (not shown) of the server 300 may combine the electronic document with the mark so as to provide the secured electronic document. Without converting the information encoded with the biometric data standard into the mark, the electronic signature combining unit may combine the information encoded with the biometric data standard with the meta field of the electronic document so as to provide the secured electronic document. Here, once the electronic signature combining unit combines the electronic document with the mark or combines the meta field of the electronic document with the information encoded with the biometric data standard, the electronic document storage management unit (not shown) of the server 300 stores the electronic document as a signed electronic document in the storage unit 200.

Another embodiment will be described. The element acquisition unit (not shown) installed in the server 300 may receive, from the terminal device 100, (1) the biometric information to be inserted into the electronic document, (2) the hash value of the electronic document, and (3) the biometric information acquisition time information. Furthermore, the biometric information processing unit positioned in the server 300 inserts the hash value of the electronic document and the acquisition information into the biometric information as a watermark, and converts the biometric information including the watermark into a mark. Next, the electronic signature combining unit included in the server 300 may combine the electronic document with the mark.

Another embodiment will be described. The element acquisition unit (not shown) installed in the server 300 may receive, from the terminal device 100, the biometric information to be inserted into the electronic document in the form of a first image or in the form of the characteristic information extracted therefrom, and may acquire the hash value of the electronic document and the acquisition information. When receiving the biometric information in the form of the characteristic information extracted from the biometric information in the form of the first image, the biometric information processing unit positioned in the server 300 converts the characteristic information into a form of a second image. Furthermore, the biometric information processing unit may insert the hash value of the electronic document and the acquisition information into the second image obtained by converting the characteristic information extracted from the biometric information, as a watermark. The electronic signature combining unit of the server 300 may convert the second image including the watermark into a mark, and then may combine the electronic document with the mark so as to provide the secured electronic document. Alternatively, the second image including the watermark may be combined with the meta field of the electronic document so as to provide the secured electronic document, without converting the second image including the watermark into the mark.

For another example of a remote system, the element acquisition unit (not shown) of the server 300 may receive, from the terminal device, the biometric information to be inserted into the electronic document, the hash value of the electronic document, and the acquisition information. Furthermore, the biometric information processing unit installed in the server 300 may insert the hash value of the electronic document and the acquisition information into the biometric information as a watermark. The electronic signature combining unit of the server 300 may combine the biometric information including the watermark with the meta field of the electronic document so as to provide the secured electronic document. Here, the biometric information processing unit may further perform encoding of the biometric information including the watermark with the biometric data standard. In this case, the electronic signature combining unit may combine the biometric information including the watermark encoded with the biometric data standard with the meta field of the electronic document so as to provide the secured electronic document.

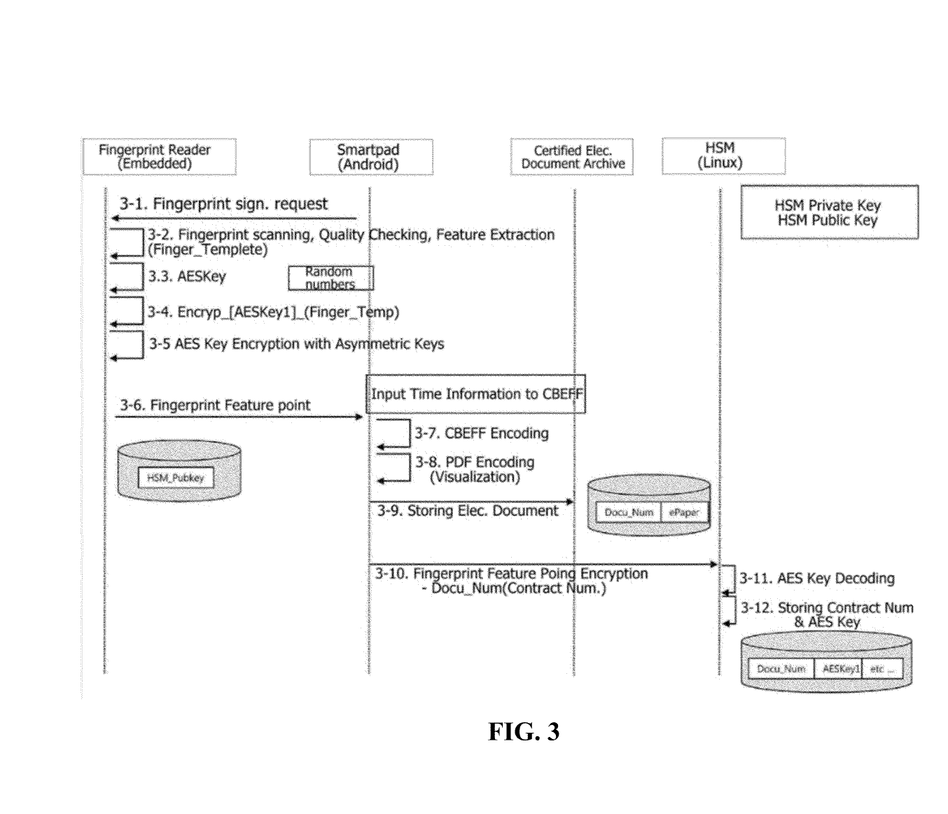

FIG. 3 is a diagram illustrating an exemplary process of generating an electronic document based on a fingerprint signature according to an embodiment of the disclosed technology. The elements illustrated in FIG. 3, i.e., a fingerprint reader, a smart pad, a certified electronic document archive, and an HSM, exemplarily correspond to the biometric information acquisition device 10, the terminal device 100, the storage unit 200, and the server 300 of FIG. 1.

It should be understood that the descriptions below regarding the encrypting step or type, the decoding step or type, the encoding step or type, and the feature point extracting step are examples only and other implementations are also possible.

Referring to FIG. 3, the smart pad sends a signal for requesting a fingerprint signature to the fingerprint reader (step 3-1). Then, the fingerprint reader scans a fingerprint of a user to obtain a fingerprint image with satisfactory resolution, and extracts characteristic information from the fingerprint image (a so-called fingerprint template) (step 3-2). In some implementations, characteristic information extracted from the fingerprint image includes a feature point of the fingerprint image. An advanced encryption standard (AES) key for encrypting the characteristic information of the fingerprint, i.e., the fingerprint template, is generated using random numbers (step 3-3), and the fingerprint template may be encrypted using the AES key (step 3-4). Next, the AES key itself is encrypted with asymmetric keys (step 3-5). The fingerprint reader transmits the encrypted fingerprint template and the AES key encrypted with the asymmetric keys to the smart pad (step 3-6).

The smart pad that has received the foregoing data inputs the data, the hash value extracted from the electronic document, and fingerprint signature time information acquired from Android time information into a CBEFF to perform CBEFF encoding (step 3-7). The fingerprint signature time information may be acquired from, for example, OS time information such as Android time information. Furthermore, PDF encoding for visualization may be performed to generate a mark (step 3-8). Next, the part is combined with the electronic document so as to provide the secured electronic document, and the secured electronic document is transmitted to the certified electronic document archive and stored therein (step 3-9). At this time, the smart pad transmits the asymmetric-key-encrypted AES key and an identification number (e.g., a contract number) for the secured electronic document to the HSM. The HSM receives the asymmetric-key-encrypted AES key and the identification number of the secured electronic document to decode the asymmetric-key-encrypted AES key (step 3-10), and the decoded AES key and the identification number of the secured electronic document are stored (step 3-11).

Configuration of Overall System for Verifying Electronic Document into Which Electronic Signature is Inserted Based on Biometric Information Recognition

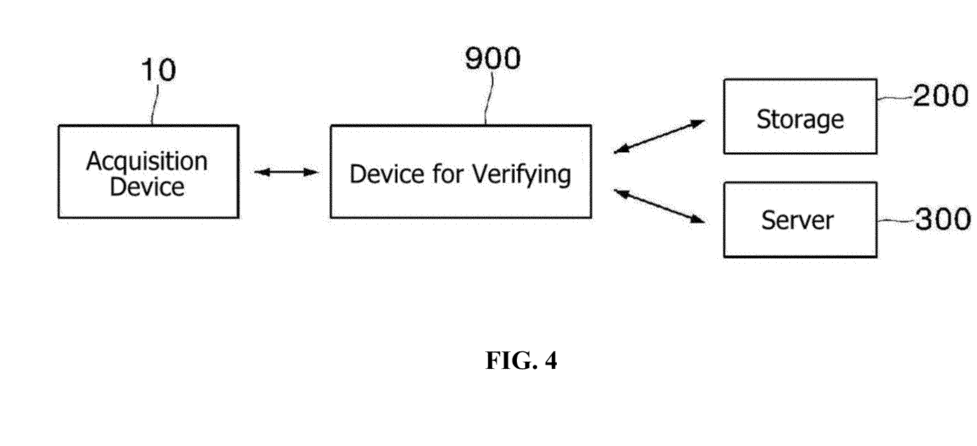

FIG. 4 is a schematic block diagram illustrating a configuration of an overall system for verifying an electronic document into which an electronic signature is inserted based on biometric information recognition according to another embodiment of the disclosed technology.

As illustrated in FIG. 4, an electronic document verifying system according to the disclosed technology may include a biometric information acquisition device 10, a terminal device 900 for verifying an electronic document (hereinafter, referred to as a terminal device 900), a storage unit 200, and a server 300. In some implementations, the terminal device 900 may be implemented with the same device as the terminal device 100 in FIG. 1.

The foregoing elements may communicate with each other wirelessly and/or by wire.

The terminal device 900 may include a digital device for enabling a user to access and communicate with the storage unit 200 and/or the server 300 through a communication network. The terminal device 900 may include an electronic device such as a personal computer (e.g., a desktop computer, a laptop computer, or the like), a workstation, a PDA, a web pad, a smartphone, a tablet PC, or the like. Any electronic device including a memory, a microprocessor, or the like may be adopted as the terminal device 900 in various implementations of the disclosed technology.

The terminal device 900 according to the disclosed technology verifies an electronic document into which biometric information is inserted as an electronic signature. The terminal device 900 checks the integrity of the electronic document to be verified, and efficiently prevents a denial of a valid electronic signature. This will be described in more detail in the below.

The biometric information acquisition device 10 may be connected to the terminal device 900, and may collect the biometric information from a user. In some implementations, the biometric information acquisition device 10 may not be separate from the terminal device 900, and be built in or integrated with the terminal device 900. For example, the biometric information may be acquired using a touch screen or a camera module included in the terminal device 9000. In this case, the biometric acquisition device 10 may be configured with a touch screen or a camera module of the terminal device 900.

The storage unit 200 stores a secured electronic document into which an electronic signature is inserted. In some embodiments, the storage unit 200 is positioned in an internal memory of the terminal device 900. In other embodiments, the storage unit 200 may be present outside the terminal device 900. In this case, the terminal device 900 may access data stored in the storage unit 200 through a communication network.

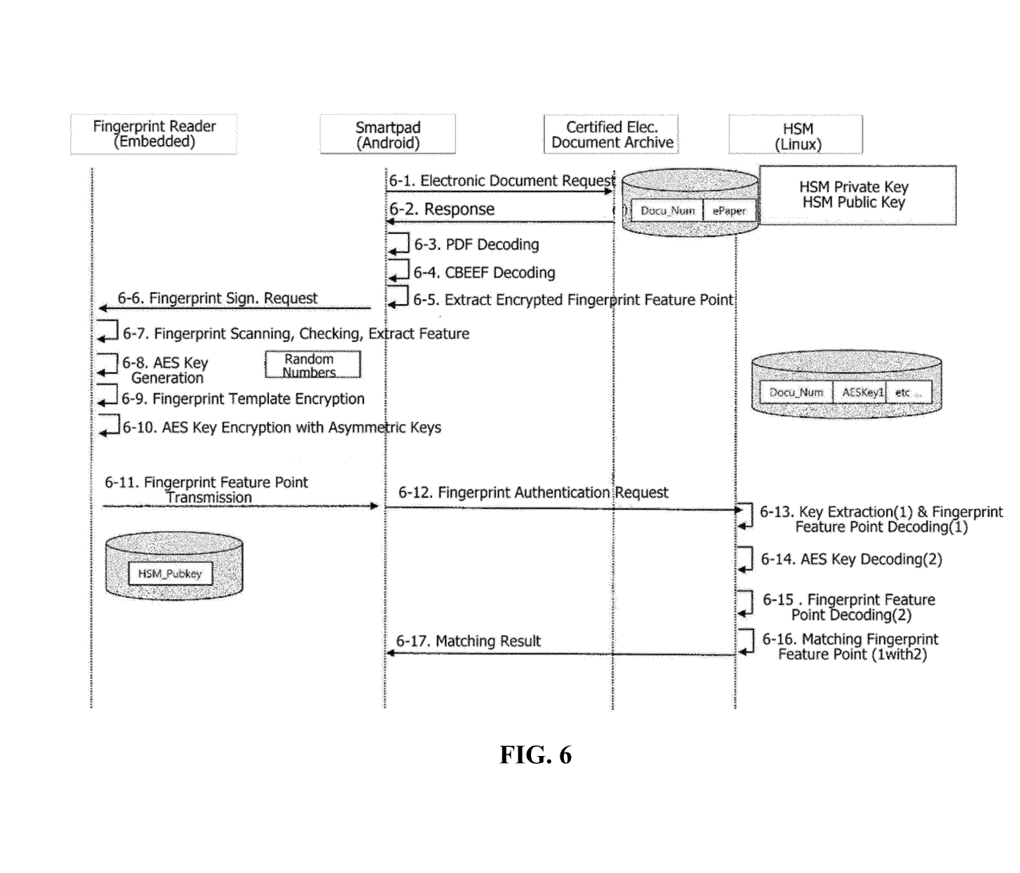

The server 300 receives and processes a request from the terminal device 900. The server 300 may compare the biometric information inserted as the electronic signature into the electronic document with the biometric information acquired from the biometric information acquisition device 10, and may transmit a result of the comparison to the terminal device 900. The server 300 will be described in more detail with reference to FIG. 6.

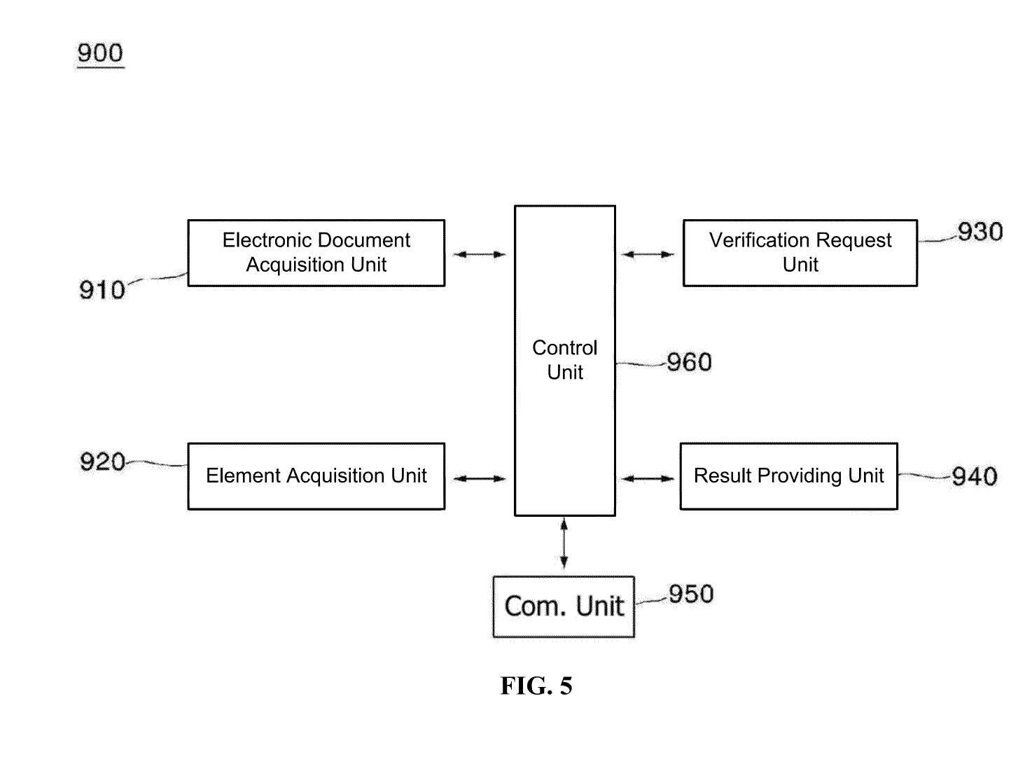

FIG. 5 is a block diagram illustrating an exemplary configuration of the terminal device 900.

As illustrated in FIG. 5, the terminal device 900 may include an electronic document acquisition unit 910, an element acquisition unit 920, a verification request unit 930, a result providing unit 940, a communication unit 950, and a control unit 960. In some implementations of the disclosed technology, some elements of the terminal device 900 may be configured as program modules. Such a program module may be included in the terminal device 900 in various forms including an operating system, an application program module, or other program modules. Such a program module may be stored in various memory devices. Furthermore, such a program module may be stored in a remote memory device communicable with the terminal device 900. Furthermore, such a program module may include a routine, a subroutine, a program, an object, a component, a data structure, or the like for performing specific tasks or processing specific data as described below.

The electronic document acquisition unit 910 may serve to acquire an electronic document to be verified. In some implementations, the electronic document acquisition unit 910 may acquire an electronic document with which a mark is combined. As discussed above, the mark is generated by encoding the following information with the biometric data standard and converting the encoded information into the mark:

(1) original or raw unencoded biometric information included in the electronic document to be verified, wherein the biometric information includes biometric information itself or characteristic information acquired from the biometric information; (2) a hash value of the electronic document; and (3) acquisition information, for example, time information at which the biometric information (the biometric information itself or characteristic information of the biometric information) in the electronic document obtained.

The element acquisition unit 920 obtains the encoded information which has been encoded with the biometric data standard from the mark combined with the acquired electronic document. Furthermore, the information encoded with the biometric data standard may be decoded to extract (1) the original or raw biometric information, (2) the hash value of the electronic document, and (3) the acquisition information for the biometric information. Such extracted data is used for verifying the integrity of the electronic document and prevent denial of the electronic document.

The verification request unit 930 may compare data extracted from the encoded information with data acquired from the electronic document acquisition unit 910 or element acquisition unit 920. In some implementation, the verification request unit 930 may perform the comparison between the hash value extracted from the information encoded with the biometric data standard and the hash value directly obtained from the electronic document. In some implementations, the verification request unit 930 may perform comparison between the extracted biometric information and the biometric information obtained from a user to be verified. In some implementations, the verification request unit 930 transfers the request for comparison to the server 300 instead of performing the comparison by itself.

Upon the comparison, if the extracted hash value from the encoded information matches the hash value obtained from the electronic document, the result providing unit 940 provides result that confirms the integrity of the electronic document. In this case, it is considered that the electronic document has not been falsified. Likewise, if the extracted biometric information matches the biometric information from the user to be verified, the result providing unit 940 provides result that confirms the authenticity of the electronic signature of the electronic document, thereby preventing denial of the signature. The terminal device 900 for verification according to the disclosed technology may be variously configured or modified in various manners. In some implementations, the configurations of the terminal device 900 for verification may correspond to the various configurations of the above-mentioned terminal device 100 for providing the secured electronic document.

For example, in another implementation, the electronic document acquisition unit 910 may obtain an electronic document to be verified, wherein the meta field of the electronic document is combined with following encoded information according to the biometric data standard: the biometric information included in the electronic document, the hash value of the electronic document, and the acquisition information of the biometric information included in the electronic document.

The element acquisition unit 920 may acquire the information encoded with the biometric data standard from the meta field of the electronic document, and may decode the information encoded with the biometric data standard so as to extract the biometric information, the hash value for the source document of the electronic document, and the acquisition information of the biometric information included in the electronic document.

The verification request unit 930 may compare the extracted hash value with the hash value directly obtained from the electronic document. In some implementations, the verification request unit 930 may compare the extracted biometric information with the biometric information inputted from the user to be verified. If the extracted hash value matches the hash value directly obtained from the electronic document, the result providing unit 940 may provide the result that confirms the integrity of the electronic document, which indicates that the electronic document has not been falsified. Furthermore, if the extracted biometric information matches the biometric information input from the user to be verified, the result providing unit 940 may provide the result that confirms the authenticity of the electronic signature of the electronic document and prevents denial of the electronic signature.

Another example of the terminal device for verification will be described. The electronic document acquisition unit 910 may serve to acquire an electronic document to be verified, wherein the electronic document to be verified may be combined with a mark. As discussed above, in some implementations, the mark is generated by inserting the hash value for the source document of the electronic document and the acquisition information of the biometric information into the biometric information as a watermark and converting the biometric information including the watermark to the mark.

The element acquisition unit 920 may convert the mark combined with the electronic document so as to acquire the biometric information including the watermark, and may extract the hash value for the electronic document and the acquisition information of the biometric information included in the electronic document from the biometric information including the watermark.

The verification request unit 930 may compare the extracted hash value with the hash value directly obtained from the source document of the electronic document. Furthermore, the verification request unit 930 may compare the acquired biometric information and the biometric information inputted from the user to be verified.

If the hash value extracted through the watermark module matches the hash value directly obtained from the source document of the electronic document, the result providing unit 940 may provide the result that confirms the integrity of the electronic document, which indicates that the electronic document has not been falsified. Furthermore, if the acquired biometric information matches the biometric information directly inputted from the user to be verified, the result providing unit 940 may provide the result that confirms the authenticity of the electronic signature of the electronic document.

Alternatively, the biometric information into which the hash value for the electronic document to be verified and the acquisition information of the biometric information included in the electronic document are inserted as a watermark may be encoded with the biometric data standard, and the electronic document combined with a mark generated by converting the information encoded with the biometric data standard may be acquired. In this case, the acquired electronic document may be verified as described below.

The element acquisition unit 920 may convert the mark combined with the acquired electronic document so as to obtain the biometric information encoded with the biometric data standard, and then may decode the encoded biometric information to restore the biometric information, thereby obtaining the biometric information including the watermark.

In some implementations, the electronic document acquisition unit 910 may compress the biometric information into which the hash value for the source document of the electronic document to be verified and the acquisition information of the biometric information included in the electronic document are inserted as a watermark with a compressing algorithm, and then convert the compressed information to acquire the electronic document combined with a mark. In this case, the element acquisition unit 920 may convert the mark combined with the acquired electronic document so as to obtain the compressed biometric information, and then may restore the biometric information not compressed, thereby obtaining the biometric information including the watermark.

Another embodiment will be described for the case that the characteristic information is extracted from the biometric information that is configured as a first image used for an electronic signature in the electronic document and the extracted characteristic information is converted into a second image. In this case, the electronic document acquisition unit 910 may acquire the electronic document to be verified, which is combined with a mark that has been obtained by converting the biometric information included as the second image. In some implementations, a watermark is inserted to the biometric information in the form of the second image and the watermark includes the acquisition information of the biometric information in the form of the first image included in the electronic document and the hash value of the electronic document.

For another example, the electronic document acquisition unit 910 may acquire the electronic document having a meta field combined with the biometric information in the form of the second image. In some implementations, a watermark is inserted to the biometric information in the form of the second image and the watermark includes the acquisition information of the biometric information in the form of the first image included in the electronic document and the hash value of the electronic document.

The element acquisition unit 920 may acquire the biometric information as the second image, which includes the watermark by converting the mark combined with the electronic document, or may acquire the biometric information as the second image, which is combined with the meta field of the electronic document. Furthermore, the hash value for the electronic document and the acquisition information of the biometric information as the first image included in the electronic document may be extracted from the biometric information as the second image including the watermark.

The verification request unit 930 may compare the extracted hash value with the hash value directly obtained from the source document of the electronic document. Furthermore, the verification request unit 930 may compare the biometric information included as the first image and the biometric information inputted from the user to be verified.

In another embodiment of the disclosed technology, the electronic document acquisition unit 910 may acquire the electronic document to be verified, the electronic document having a meta field combined with the biometric information into which the hash value for the electronic document and the acquisition information of the biometric information included in the electronic document are inserted as a watermark. The element acquisition unit 920 may acquire the biometric information including the watermark from the meta field of the electronic document. Furthermore, the hash value for the electronic document and the acquisition information of the biometric information included in the electronic document may be extracted from the biometric information including the watermark. In the present embodiment, the verification request unit 930 may compare the extracted hash value and the hash value directly obtained from the electronic document. Furthermore, the verification request unit 930 may compare the biometric information extracted using the watermark and the biometric information inputted from the user to be verified.

If the extracted hash value matches the hash value directly obtained from the electronic document, the result providing unit 940 may provide the result that confirms the integrity of the electronic document, which indicates that the electronic document has not been falsified. Furthermore, if the biometric information acquired using the watermark matches the biometric information directly inputted from the user, the result providing unit 940 may provide the result that confirms the authenticity of the electronic signature of the electronic document.

Furthermore, the verification subject document acquired by the electronic document acquisition unit 910 may have a meta field combined with the biometric information into which the hash value for the electronic document and the acquisition information of the biometric information included in the electronic document are inserted as a watermark. In some implementations, the biometric information into which the watermark is inserted may have been encoded with the biometric data standard. In this case, the element acquisition unit 920 may acquire the biometric information encoded with the biometric data standard from the meta field of the acquired electronic document, and then may decode the biometric information encoded with the biometric data standard so as to restore the biometric information not encoded, thereby obtaining the biometric information.

It has been described that the steps for verifying an electronic document using biometric information are performed in the terminal device 900. However, some steps may be remotely performed using the server 300.

For example, the server 300 may include an electronic document acquisition unit, an element acquisition unit, an element comparison unit, a result providing unit. In some implementations, upon receiving a request for verifying a specific electronic document from the terminal device 900, the electronic document acquisition unit (not shown) installed in the server 300 may acquire a source document of the electronic document combined with a mark generated by encoding, with the biometric data standard, the biometric information included in the electronic document, the hash value for the electronic document, and the acquisition time information of the biometric information included in the electronic document. The electronic document may be received in various manners. For example, the electronic document may be received from the storage unit 200 directly or via the terminal device 900.

The element acquisition unit (not shown) positioned in the server 300 may convert the mark part combined with the source document of the acquired electronic document so as to obtain the information encoded with the biometric data standard. Furthermore, the element acquisition unit may decode the information encoded with the biometric data standard, so as to extract (1) the biometric information, (2) the hash value for the electronic document, and (3) the acquisition information of the biometric information included in the electronic document.

An element comparison unit (not shown) installed in the server 300 may compare the hash value extracted from the information encoded with the biometric data standard with the hash value directly obtained from the electronic document. Furthermore, the element comparison unit may compare the biometric information extracted from the information encoded with the biometric data standard with the biometric information input from the user to be verified. If the extracted hash value matches the hash value directly obtained from the electronic document, a result providing unit (not shown) installed in the server 300 may provide, to the terminal device 900, the result confirming the integrity of the electronic document, which indicates that the electronic document has not been falsified. Furthermore, if the extracted biometric information matches the biometric information input from the user, the result providing unit may provide, to the terminal device 900, the result confirming the authenticity of the electronic signature of the electronic document.

Another example of electronic document verification by server will be described. The electronic document acquisition unit (not shown) installed in the server 300 may receive a request for verifying a specific electronic document from the terminal device 900. The electronic document acquisition unit may acquire a the electronic document having a meta field combined with information obtained by encoding, with the biometric data standard, the biometric information of the electronic document, the hash value for the electronic document, and the acquisition information of the biometric information included in the electronic document. The element acquisition unit (not shown) installed in the server 300 may acquire the information encoded with the biometric data standard from the meta field of the source document of the electronic document, and may decode the information encoded with the biometric data standard so as to extract the biometric information, the hash value for the electronic document, and the acquisition information on the biometric information included in the electronic document. The element comparison unit (not shown) installed in the server 300 may compare the extracted hash value with the hash value directly obtained from the electronic document, and may compare the extracted biometric information with the biometric information inputted from the user. If the extracted hash value matches the hash value directly obtained from the electronic document, the result providing unit (not shown) installed in the server 300 may provide, to the terminal device 900, the result that approves the integrity of the electronic document, which indicates that the electronic document has not been falsified. Furthermore, if the extracted biometric information matches the biometric information inputted from the user, the result providing unit may provide, to the terminal device 900, the result that confirms the authenticity of the electronic signature of the electronic document.

Another example will be described. The electronic document acquisition unit (not shown) installed in the server 300 may receive a request for verifying a specific electronic document from the terminal device 900. In the present embodiment, the verification subject electronic document acquired may be or include a document combined with a mark. The mark is generated by converting the biometric information into which the hash value for the electronic document and the acquisition information of the biometric information included in the electronic document are inserted as a watermark. The element acquisition unit (not shown) installed in the server 300 converts the mark combined with the acquired electronic document so as to obtain the biometric information including the watermark. Furthermore, the hash value for the electronic document and the acquisition information of the biometric information included in the electronic document may be extracted from the biometric information including the watermark. The element comparison unit (not shown) installed in the server 300 may compare the hash value extracted from the watermark with the hash value directly obtained from the electronic document. Furthermore, the biometric information acquired from the watermark may be compared with the biometric information input from the user. If the extracted hash value matches the hash value directly obtained from the electronic document, the result providing unit (not shown) installed in the server 300 may provide, to the terminal device 900, the result confirming the integrity of the electronic document, which indicates that the source document of the electronic document has not been falsified. Furthermore, if the acquired biometric information matches the biometric information directly input from the user, the result providing unit may provide, to the terminal device 900, the result confirming the authenticity of the electronic signature of the source document of the electronic document.

In some implementations, the electronic document to be verified and acquired by the electronic document acquisition unit may include an electronic document with which the biometric information is combined as a mark. As discussed above, the biometric information combined as a mark is obtained by inserting the hash value for the electronic document and the acquisition information of the biometric information included in the electronic document as a watermark. The biometric information into which the watermark is inserted may have been encoded with the biometric data standard. In this case, the element acquisition unit may acquire the biometric information encoded with the biometric data standard by converting the mark of the acquired electronic document, and then may decode the biometric information encoded with the biometric data standard so as to restore the biometric information not encoded, thereby obtaining the biometric information including the watermark.

Another embodiment will be described. When the electronic document acquisition unit (not shown) of the server receives a request for verifying a specific electronic document from the terminal device 900, the electronic document acquisition unit may extract the characteristic information from the biometric information included as a first image used for an electronic signature by the user in the electronic document, and may convert the extracted characteristic information into the form of a second image.

The electronic document acquisition unit (not shown) installed in the server 300 may acquire t the electronic document combined with a mark generated by converting the biometric information in the form of the second image into which the acquisition information of the biometric information included as the first image in the electronic document and the hash value for the electronic document are inserted as a watermark. Another modification may be made if necessary. For example, the characteristic information may be extracted from the biometric information in the form of the first image that is used for an electronic signature by the user in the electronic document, and the extracted characteristic information may be converted into the second image. In this case, the electronic document acquisition unit (not shown) installed in the server 300 may acquire the electronic document combined with a meta field. The meta field may be combined with the biometric information in the form of the second image into which the acquisition information of the biometric information in the form of the first image and the hash value of the electronic document are inserted as a watermark.

The element acquisition unit (not shown) installed in the server 300 may acquire the biometric information in the form of the second image including the watermark by converting the mark combined with the acquired electronic document, or may acquire the biometric information in the form of the second image combined with the meta field of the acquired electronic document. Furthermore, the hash value for the electronic document and the acquisition information of the biometric information in the form of the first image included in the electronic document may be extracted from the biometric information in the form of the second image including the watermark. Furthermore, the element comparison unit (not shown) installed in the server 300 may compare the extracted hash value with the hash value directly obtained from the electronic document, and may compare the biometric information in the form of the first image with the biometric information inputted from the user.

Another embodiment for verifying an electronic document will be described. The electronic document acquisition unit (not shown) installed in the server 300 may receive a request for verifying a specific electronic document from the terminal device 900. Here, the electronic document acquired has a meta field combined with the biometric information. The biometric information into which the hash value for the electronic document and the acquisition information of the biometric information included in the electronic document are inserted as a watermark is combined with the meta field.

The element acquisition unit installed in the server 300 may acquire the biometric information including the watermark from the meta field of the electronic document acquired. Furthermore, the element acquisition unit may extract the hash value for the electronic document and the acquisition information of the biometric information included in the electronic document from the biometric information including the watermark.

The element comparison unit (not shown) included in the server 300 may compare the hash value extracted from the watermark with the hash value directly obtained from the electronic document. Furthermore, the element comparison unit may compare the acquired biometric information with the biometric information inputted from the user. If the extracted hash value matches the hash value directly obtained from the electronic document, the result providing unit (not shown) included in the server 300 may provide, to the terminal device, the result confirming the integrity of the electronic document, which indicates that the electronic document has not been falsified. Furthermore, if the acquired biometric information matches the biometric information directly input from the user, the result providing unit may provide, to the terminal device, the result confirming the authenticity of the electronic signature of the electronic document.

Furthermore, the document to be verified and acquired by the electronic document acquisition unit may be or include an electronic document having a meta field combined with the biometric information into which the hash value for the electronic document and the acquisition information included in the electronic document are inserted as a watermark. Here, the biometric information into which the watermark is inserted may have been encoded with the biometric data standard. In this case, the element acquisition unit may acquire the biometric information encoded with the biometric data standard from the meta field of the acquired electronic document, and then may decode the biometric information encoded with the biometric data standard so as to restore the biometric information not encoded, thereby obtaining the biometric information including the watermark.

FIG. 6 is a diagram illustrating an exemplary process of verifying an electronic document according to an embodiment of the disclosed technology. The elements illustrated in FIG. 6, i.e., a fingerprint reader, a smart pad, a certified electronic document archive, and an HSM, exemplarily correspond to the biometric information acquisition device 10, the terminal device 900, the storage unit 200, and the server 300 of FIG. 4. The encrypting step or type, the decoding step or type, the encoding step or type, and the feature point extracting step described below with reference to FIG. 6 may be variously modified as described above with respect to various embodiments.

Referring to FIG. 6, the smart pad may send a request for an electronic document to be verified to the certified electronic document archive (step 6-1). The certified electronic document archive that has received the request transmits an identification number of a stored electronic document and the electronic document to the smart pad (step 6-2). Once the smart pad acquires the electronic document to be verified, the smart pad may extract an encrypted fingerprint feature point (as an example of characteristic information from the fingerprint) from a mark combined with the electronic document (step 6-5). Before the encrypted fingerprint feature point is extracted, PDF decoding may be performed (step 6-3), and CBEFF decoding may be performed (step 6-4). As described above, in some embodiments, an unencrypted fingerprint feature point may be extracted.

Furthermore, the data extracted in step 6-5 may include a hash value for the electronic document and fingerprint acquisition time information in addition to the fingerprint feature point.

Next, the smart pad initiates a biometric information acquisition process (step 6-6). For example, a fingerprint reader is operated so as to prepare to scan a fingerprint of a user who argues to be a true signer of the electronic document. Next, the fingerprint reader may scan the fingerprint of the user, and may extract the fingerprint feature point from a scanning image with satisfactory resolution (step 6-7).

Furthermore, the fingerprint reader may generate an AES key using random numbers (step 6-8). The fingerprint feature point is encrypted using the AES key (step 6-9). Then, the fingerprint reader may encrypt the AES key with asymmetric keys (step 6-10), and may transmit the encrypted fingerprint feature point (fingerprint feature point directly scanned from the user) and the AES key encrypted with the asymmetric keys to the smart pad (step 6-11).

Next, the smart pad transmits, to the HSM, the encrypted fingerprint feature point received from the fingerprint reader and the encrypted fingerprint feature point directly extracted from the electronic document acquired from the certified electronic document archive together with the AES key encrypted with the asymmetric keys (step 6-12). The HSM decodes the fingerprint feature point extracted from the source document of the electronic document using the AES key previously stored (step 6-13). Thereafter, the HSM decodes the AES key transmitted from the fingerprint reader (step 6-14), and then decodes the fingerprint feature point transmitted from the fingerprint reader (fingerprint feature point directly scanned from the user) using the AES key (step 6-15). Furthermore, the HSM matches the fingerprint feature point extracted from the electronic document to the fingerprint feature point directly scanned from the user (step 6-16). Then, the HSM transmits a result of the matching to the smart pad (step 6-17).

The above-description with reference to FIG. 6 is focused on a process of identifying a user through matching between fingerprint feature points and preventing denial of a signature. However, as described above, the PDF decoding may be performed on a mark combined with the electronic document (step 6-3), and the CBEFF decoding may be performed (step 6-4), so that the hash value for the electronic document such as a fingerprint feature point may be compared with the hash value directly extracted from the electronic document to verify the integrity of the electronic document.

The above-mentioned various embodiments according to the disclosed technology may be implemented as program commands executable by various computer components so as to be recorded in a computer-readable recording medium. The computer-readable recording medium may include program commands, data files, and data structures, taken alone or in combination. The program commands recorded in the computer-readable recording medium may be specially designed for the present invention or may be well known and available in the technical fields of computer software. Examples of the computer-readable recording medium include hardware devices specially configured to store and perform program commands, such as hard disks, floppy disks, magnetic media such as magnetic tapes, optical media such as CD-ROMs or DVDs, magneto-optical media such as floptical disks, ROMs, RAMs, or flash memories. Examples of the program commands include not only machine language codes produced by compilers but also high-level language codes that can be executed by computers using interpreters. The above-mentioned hardware device may be configured to be operated as one or more software modules for performing operations of the disclosed technology, and vice versa.

According to the various implementations of the disclosed technology, an electronic signature is inserted based on biometric signal recognition so that a secured electronic document may be efficiently generated.

Furthermore, according to the disclosed technology, the integrity of the electronic document may be effectively secured when an authenticity issue occurs with respect to the electronic document into which an electronic signature based on biometric signal recognition is inserted.

Moreover, in comparison with a conventional electronic signature that can be easily forged through image editing, it is possible to effectively prevent the forgery of the electronic signature and denial of the true signature.

The above-disclosed subject matter is to be considered illustrative, and not restrictive, and the appended claims are intended to cover all such modifications, enhancements, and other embodiments, which fall within the true spirit and scope of the disclosed technology. Thus, to the maximum extent allowed by law, the scope of the disclosed technology is to be determined by the broadest permissible interpretation of the following claims and their equivalents, and shall not be restricted or limited by the foregoing detailed description.

What is claimed is:

1. A method for providing a secured electronic document by a biometric information recognition device, the method comprising:
acquiring biometric information to be inserted into an electronic document;
encoding the biometric information according to a biometric data standard together with a hash value of the electronic document and acquisition time information of the biometric information; and
integrating the encoded biometric information with the electronic document to provide a secured electronic document.

2. The method of claim 1, wherein the acquiring of biometric information includes obtaining a characteristic portion from the biometric information.

3. The method of claim 1, further comprising, after the encoding the biometric information, converting the encoded biometric information into a mark so that the biometric information is visualized in the secured electronic document.

4. The method of claim 1, wherein the integrating the encoded biometric information comprises combining the encoded biometric information with a meta field of the electronic document so that the biometric information is non-visually included in the secured electronic document.

5. The method of claim 1, wherein the biometric data standard includes a common biometric exchange file format (CBEFF).

6. The method of claim 1, wherein the acquiring the biometric information comprises acquiring encrypted information of the biometric information.

7. The method of claim 1, wherein the biometric information includes a fingerprint.

8. The method of claim 1, wherein the encoding the biometric information comprises encoding the biometric information together with an acquisition organ of the biometric information.

9. The method of claim 3, wherein the mark includes a barcode, a QR code, or any visualized identification mark.

10. A method for verifying an electronically signed electronic document, the method comprising:
receiving a verification request from a user terminal together with user's biometric information;
acquiring an electronic document to be verified, the electronic document to be verified combined with an encoded biometric information that is obtained by encoding original biometric information according to a biometric data standard together with a hash value of the electronic document and acquisition time information of the original biometric information;
decoding the encoded biometric information to acquire (i) the original biometric information, (ii) the hash value of the electronic document, and (iii) the acquisition time information of the original biometric information included in the electronic document;
comparing the hash value obtained from the decoding with a hash value directly obtained from the source document of the electronic document, and comparing the original biometric information with the acquired user's biometric information; and
determining, based on the comparison, authenticity of the electronic document.

11. The method of claim 10, wherein the encoded biometric information is visually combined with the electronic document.

12. The method of claim 11, wherein the encoded biometric information is combined with the electronic document in the form of a mark.

13. The method of claim 10, the encoded biometric information is combined with a meta field of the electronic document.

14. A device for providing a secured electronic document, comprising:
a biometric information acquisition unit configured to acquire biometric information to be inserted into an electronic document;
a biometric information processing unit configured to encode the biometric information together with a hash value of the electronic document, and acquisition time information of the biometric information; and
an electronic signature combining unit configured to integrate the encoded biometric information with the electronic document to provide a secured electronic document.

15. The device of claim 14, wherein the biometric information processing unit converts the encoded biometric information into a visualized form including a mark and the electronic signature combining unit integrates the visualized form with the electronic document.

16. The device of claim 14, wherein the biometric information processing unit inserts the hash value and the acquisition time information into the biometric information as a watermark.

17. The device of claim 14, wherein the electronic signature combining unit combines the encoded biometric information with a meta field of the electronic document so that the biometric information is non-visually integrated with the electronic document.

18. The device of claim 14, wherein the biometric information processing unit encodes the biometric information according to a biometric data standard by inserting the biometric information, the hash value, and the acquisition time information into a common biometric exchange file format (CBEFF).

19. The device of claim 14, wherein the biometric information includes a fingerprint.

20. A device for verifying an electronically signed electronic document, comprising:
a reception unit configured to receive a verification request from a user terminal together with user's biometric information;
an acquisition unit configured to acquire an electronic document to be verified, the electronic document including encoded biometric information associated with raw biometric information encoded based on a biometric data standard together with a hash value of the electronic document and acquisition time information of the raw biometric information;
an extraction unit configured to obtain (i) the raw biometric information, (ii) the hash value of the electronic document, and (iii) the acquisition time information of the raw biometric information included in the electronic document; a comparison unit configured to compare the hash value obtained from the decoding with a hash value directly obtained from the source document of the electronic document, and comparing the raw biometric information with user's biometric information; and
a verification unit configured to determine, based on the comparison, authenticity of the electronic document.
